(19) United States
(12) Patent Application Publication
(10) Pub. No.: US 2008/0172715 A1
(43) Pub. Date: Jul. 17, 2008

(54) Scalable context-based authentication

(75) Inventors: Avi Rom Geiger, Seattle, WA (US); Brian Meredith Wilson, Mercer Island, WA (US); Jonathan David Friedman, Seattle, WA (US); Arnold Milton Lund, Sammamish, WA (US); Kanchen Rajanna, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/653,119

(22) Filed: Jan. 12, 2007

(51) Int. Cl. H04L 9/00

(52) U.S. Cl. 726/1

(57) ABSTRACT

A portable processing device or system may permit a user to access a resource when a certain number of keys are present, according to an authentication policy and a context in which the certain number of keys are provided. In some contexts fewer or no keys may be required, while in other contexts more keys may be required. The authentication policy may be adaptable, such that a precautionary action may be taken when a previously unused combination of keys and a context are used. Further, the authentication policy may require a fewer number of keys close to a time of a last successful authentication and may require a larger number of keys as time passes since the last successful authentication. In some embodiments, a type of visual feedback of entered password text may change based on a security level.

### BACKGROUND

Password entry on a portable processing devices may be burdensome to users who may need to remember a large number of passwords for many processing devices. Often, users choose not to have a password, thereby trading convenience for security.

When a user enters a password, the user may refer to onscreen feedback during text entry of the password. With some input devices, such as, for example, a soft keyboard or a handwriting recognition device, users may rely entirely on accurate visual feedback while inputting text. When an input process is less than perfect, such as, for example, handwriting recognition or touching of keys, such as, for example, soft keys or other keys, feedback is especially important for the user to understand why text input was not accepted.

Password entry is treated differently from other types of text input. Typically, if the user enters a password incorrectly, the user is forced to reenter the entire password. Not only is the user required to reenter the entire password, but the user is not provided with any information regarding what was wrong with the previously entered password. For example, a user may reenter a password many times before realizing that caps lock was on. This can be a very frustrating experience for the user.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

A processing device or system may be provided which may permit a user access to a resource, such as, for example, files on the processing device or the system, or another resource, when a certain number of “keys” from at least one group of keys are present. The certain number of keys may be based on a context in which the user attempts to access the resource.

In various embodiments consistent with the subject matter of this disclosure, a number of different types of keys may be used to gain access to the resource. Types of keys may include, but not be limited to, presence of a home network, a particular location of a portable processing device or system (as provided by a GPS or other device), presence of a particular device or storage media connected to the processing device or system, conventional passwords, biometrics (fingerprint recognition, voice recognition, face recognition, retinal scan, or other biometrically identifying information), time of day, presence of a Bluetooth enabled cell phone, presence of a radio frequency (RF) key fob, one-time-keys, calendar information from a scheduling application or other source, or other types of keys.

In some embodiments, a user may establish an authentication policy which may permit a simple proximity-based method of authentication to be used when the portable processing device or the system is in low-risk locations, but may require entry of one or more secure passwords while the user is traveling with the portable processing device or the system.

In other embodiments, the user may establish a context-based authentication policy, which may include time, location, and/or other criteria. For example, fewer or no keys may be required to gain access to a resource when a location of the portable processing device or the system is determined to be a low-risk location, while more keys may be required to gain access to the resource when the location of the portable processing device or the system is determined to be a high-risk location.

In some embodiments, the authentication policy may adapt in response to recognized usage patterns. For example, a precautionary action may be taken in response to an access request for the resource, which does not match any recognized usage patterns.

In yet other embodiments consistent with the subject matter of this disclosure, feedback, such as, for example, visual feedback, may be provided when a user enters password text. A type of visual feedback may be configurable or may change based on the authentication policy and a context in which access to the resource is requested.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary processing device or system which may be used to implement embodiments consistent with the subject matter of this disclosure.

FIG. 2 is a flowchart of an exemplary process which may be implemented in embodiments consistent with the subject matter of this disclosure.

FIG. 3A illustrates an exemplary slider which may be used to set a security level in embodiments consistent with the subject matter of this disclosure.

FIG. 3B illustrates an exemplary display including options, which the user may select in order to set a security level and to assign particular point values to particular types of keys.

FIGS. 4A-4F illustrate exemplary methods of providing visual feedback during password text entry in embodiments consistent subject matter of this disclosure.

FIGS. 5A-5C illustrate exemplary display screens which may be displayed when changing a type of visual feedback to be provided during password text entry.

FIG. 6 illustrates an exemplary display screen which may be displayed to indicate processing of non-textual keys during authentication.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Exemplary Processing Device

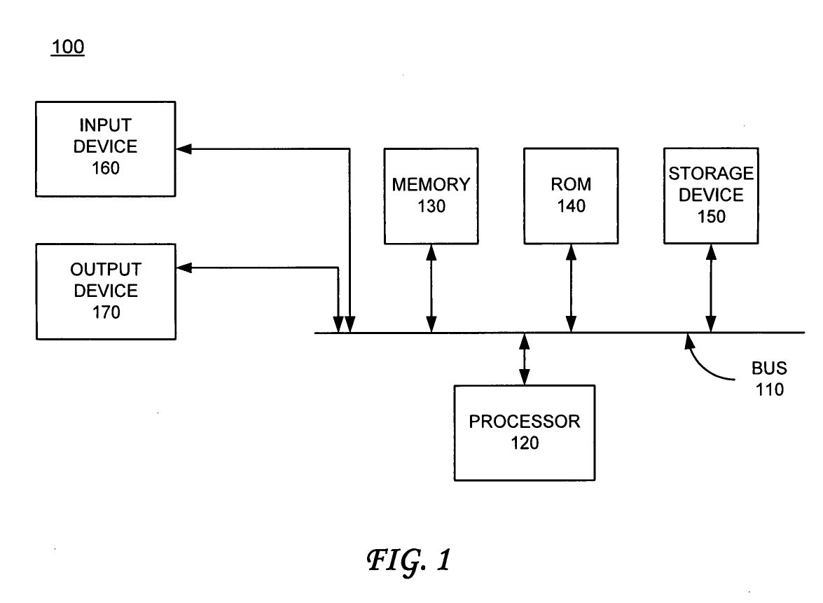

FIG. 1 is a functional block diagram that illustrates an exemplary processing device 100, which may be used in embodiments consistent with the subject matter of this disclosure. Processing device 100 may include a bus 110, a processor 120, a memory 130, a read only memory (ROM) 140, a storage device 150, an input device 160, and an output device 170. Bus 110 may permit communication among components of processing device 100.

Processor 120 may include at least one conventional processor or microprocessor that interprets and executes instructions. Memory 130 may be a random access memory (RAM) or another type of dynamic storage device that stores information and instructions for execution by processor 120. Memory 130 may also store temporary variables or other intermediate information used during execution of instructions by processor 120. ROM 140 may include a conventional ROM device or another type of static storage device that stores static information and instructions for processor 120. Storage device 150 may include any type of media for storing data and/or instructions.

Input device 160 may include one or more conventional mechanisms that permit a user to input information to processing device 100, such as, for example, a keyboard, a mouse, or other input device. Output device 170 may include one or more conventional mechanisms that output information to the user, including a display, a printer, or other output device.

Processing device 100 may perform such functions in response to processor 120 executing sequences of instructions contained in a tangible machine-readable medium, such as, for example, memory 130, or other medium. Such instructions may be read into memory 130 from another machine-readable medium, such as storage device 150, or from a separate device via a communication interface (not shown).

### Overview

Embodiments consistent with the subject matter of this disclosure provide a processing device or system which a user may configure to allow the user access to a resource, such as, for example, files on the processing device or the system, or another resource, when a certain number of “keys” from one or more groups of keys are present. The certain number of keys which must be present for the user to access the resource may be based on a context in which the user attempts to access the resource.

A number of different types of keys may be used in various embodiments. Examples of keys may include, but not be limited to, presence of a home network, a particular location of the portable processing device or system (as provided by a GPS or other device), presence of a particular device or storage media connected to the processing device or system, conventional passwords, biometrics (fingerprint recognition, voice recognition, face recognition, retinal scan, or other biometrically identifying information), time of day, presence of a Bluetooth enabled cell phone, presence of a radio frequency (RF) key fob, one-time-keys, calendar information from a scheduling application or other source, or other types of keys.

A user may establish an authentication policy which may permit a simple proximity-based method of authentication to be used when the portable processing device or system is in low-risk locations, but may require entry of secure passwords while traveling, as indicated by a scheduling application or other application or system. In other embodiments, the user may establish an authentication policy which may require secure access methods when a physical key, such as, for example, a USB fob, an SD card, or other key is absent, and may require few, if any, additional keys when the physical key is present.

The user may establish a context-based authentication policy, which may include time, location, and/or other criteria. For example, the context-based authentication policy may permit access to the resource without password entry when a location of the portable processing device or system is determined to be in a user's home. Another context-based authentication policy consistent with the subject matter of this disclosure may permit access to the resource only during certain times of the day, or may permit certain users access to the resource only during certain times of the day. In some embodiments, the authentication policy may require increased security levels depending upon an amount of time since a last successful authentication request. For example, the authentication policy may require additional keys if five minutes has passed since the last successful authentication request and may require even more keys if at least an hour has passed since the last successful authentication request.

In other embodiments consistent with the subject matter of this disclosure, the authentication policy may be adaptive in response to recognized usage patterns and may require additional authentication for an access request occurring in unfamiliar or previously unseen situations or contexts with respect to time, location, or other criteria. For example, a particular user may use a speech recognition key and the portable processing device or system may determine that, at a particular time and/or place, the same user uses the speech recognition key. The portable processing device or system may adapt to the determined pattern, such that if, at the particular time and/or place, a different user uses the speech recognition key, the portable processing device or system may determine that use of the speech recognition key varies from the determined pattern and the portable processing device or system may require additional keys, may send an alert, or may take some other action in response to determining a variance from the determined pattern.

In some embodiments consistent with the subject matter of this disclosure, points may be assigned to many system “keys” and the authentication policy may require various numbers of points to access a resource, depending on a particular situation. For example, a textual password may be assigned 10 points, being in a particular location may be assigned 2 points, voice recognition may be assigned 25 points, etc. As an example, from a high-risk location, the authentication policy may require keys to be present having a total value of at least 35 points before permitting a user to access a resource. Thus, in this example, a combination of a voice recognition key (25 points) and a textual password key (10 points) would satisfy the authentication policy for access to the resource from a high-risk location.

The system administrator may limit flexibility of the user with respect to selecting any of the above-mentioned features.

When the user enters a password, the user may be presented with a particular type of feedback, such as, for example, visual feedback, depending on a desired level of security. For example, as the user enters the password, the input text may be displayed, partially covered by dots. In another scenario, as the user enters text for the password, the characters may be displayed in a different orientation, such as, for example, horizontally flipped, or another orientation. In a third example, as password text is entered, instead of displaying characters, icons representing uppercase characters, lowercase characters, and numbers may be displayed. In a fourth example, as password text is entered, the characters may be partially displayed, such as, for example, a top half of each character, a lower half of each character, or a mixture of various portions of the characters. In a fifth example, as password text is entered, each character may be mapped to a substitute character, which may be displayed instead of the input character. In a sixth example, as each character of the password is entered, each character may be displayed briefly and may fade and be transformed into another character, such as, for example, a dot or another character.

In some embodiments, consistent with the subject matter of this disclosure, a type of visual feedback provided when a password is entered, may be configurable on a system basis or on a per user basis. In other embodiments, at least some of the methods of providing visual feedback may be assigned a particular security level. In some embodiments, a current security level, according to the authorization policy, may determine the type of visual feedback provided when a password is being entered.

### Exemplary Processing

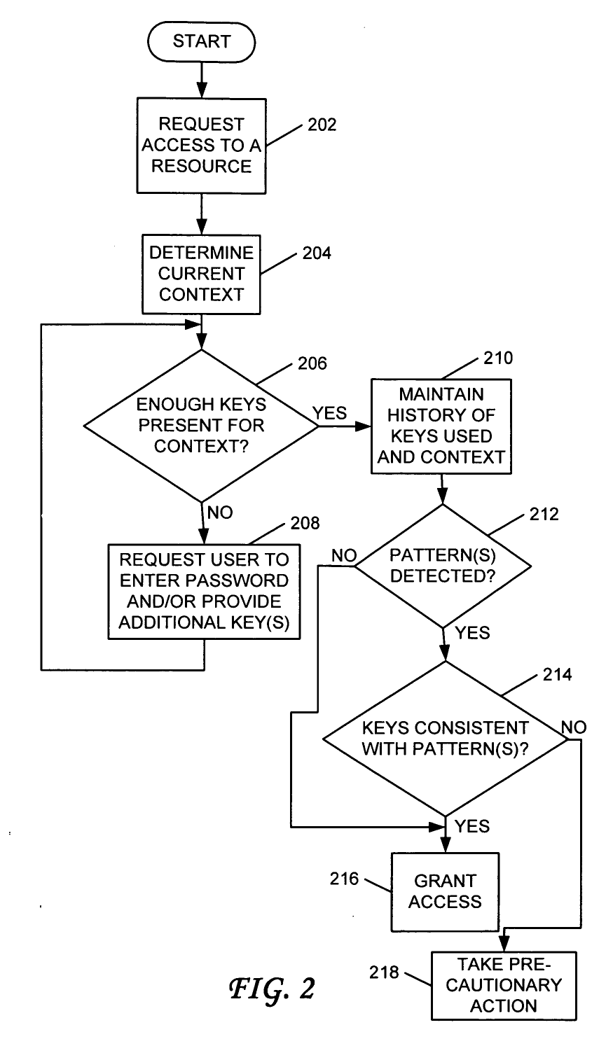

FIG. 2 is a flowchart that illustrates an exemplary process that may be implemented in an embodiment consistent with the subject matter of this disclosure, with respect to a user requesting and receiving access to a resource, such as, for example, one or more files in a portable processing device or system, or other resource. The process may begin with a user requesting access to a resource (act 202). The user may make the request by selecting one or more soft or hard keys, by selecting one or more icons on a display of a portable processing device or system, by simply turning on the portable processing device or system, or via numerous other methods.

The portable processing device or system may then determine the current context in which the request for access is being made (act 204). For example, the context may include, but not be limited to, time of day, day of week, proximity to other networks or devices, location of the portable processing device or system as may be provided by a GPS device or other device, various combinations of the above, or other contextual indicators.

The portable processing device or system may then determine, according to an authorization policy, whether there are enough “keys” present with respect to the current context (act 206). For example, according to the authorization policy, a predetermined number of “keys” must be present for a particular context before the authorization policy may grant access to the resource. For example, when the portable processing device or system is provided with location information indicating that the processing device or system is currently located in a trusted location, such as, the user's home or other trusted location, a smaller number of “keys”, or no keys, may be required to gain access to the resource. As another example, when the user's scheduling application, or other application, indicates that the user is to be at a particular location at a particular time, and the portable processing device or system is provided with information indicating that a current time is the particular time and the portable process or system is currently located at the particular location indicated by the scheduling application, or other application, fewer “keys” may be required before access is granted to the resource. Further, in an embodiment in which the keys may be assigned different point values, the portable processing device or system may determine whether enough keys are present by determining whether a total number of points of the present keys equals or exceeds a number of points required by the authorization policy in order to gain access to the resource.

If the portable processing device or the system determines that not enough keys are present, for the current context, for granting access to the resource, then the user may be prompted, via a display of the portable processing device or system, to provide a password and/or one or more other keys (act 208). The process may repeat acts 206-208 until the portable processing device or system determines that enough keys are present for the current context before granting access to the resource.

The portable processing device or system may maintain a history of keys used to gain access to the resource and the current context in which the keys were provided (act 210). The portable processing device or system may analyze the maintained history to determine whether any patterns exist with respect to the provided key(s) and the contexts in which the provided keys were used to request access to the resource (act 212). If the portable processing device or the system determines that no particular pattern is detected, then the portable processing device or system may grant access to the resource (act 216). Otherwise, the portable processing device or the system may determine whether the provided keys have been provided previously with respect to the current context when requesting access to the resource (act 214). As an example, suppose at least one of the keys is a voice of the user speaking a particular phrase or word. A pattern may have been detected indicating that only a particular user speaks the particular phrase or word in the current context, which may be, for example, a particular location on a particular weekday at a particular time. When the voice is determined to be the voice of an unfamiliar user provided in a same context, then portable processing device of the system may determine that the provided key or “keys” are not consistent with a detected pattern. In such a situation, the portable processing device or system take some form of precautionary action (act 218). Examples of precautionary action may include, but not be limited to, sending an e-mail or other type of message to a system administrator indicating a security alert, blocking the user from being granted access to the resource, requesting the user to provide one or more additional keys, or other precautionary action.

The process illustrated in FIG. 2 is exemplary. In other embodiments, different or other acts may be performed or acts may be performed in a different order.

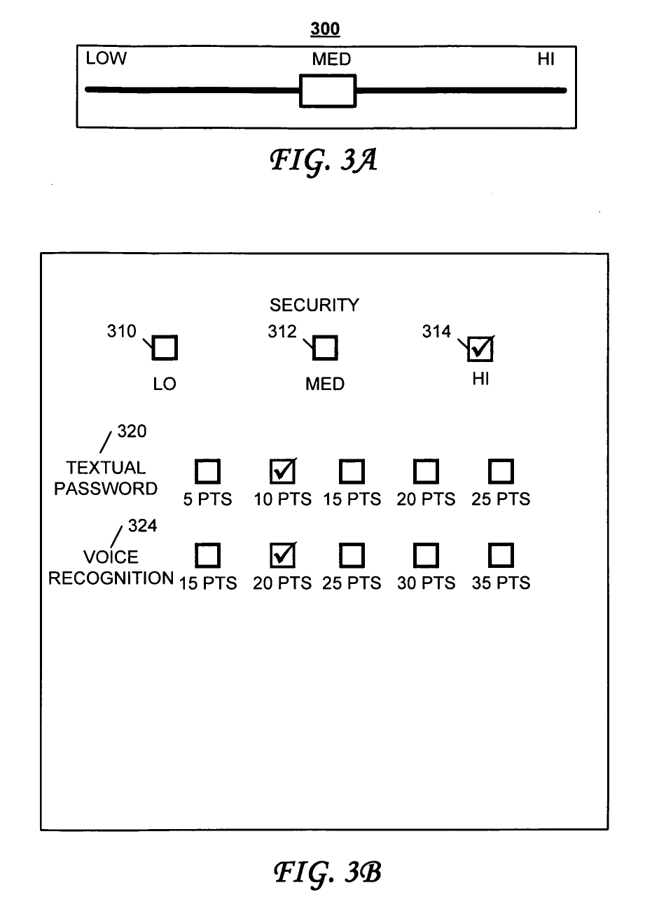

FIG. 3A illustrates an exemplary security slider 300 that may be used in embodiments consistent with the subject matter of this disclosure. A user may select slider 300 via a pointing device, such as, for example, a computer mouse or other pointing device, and may slide slider 300 to a desired setting. In the exemplary display of FIG. 3A, the user may select one of three settings, low, medium, or high. Each of the security settings may be previously established. The low security setting may require no keys or a small number of keys to be successfully authenticated for accessing a resource. The medium security setting may require several keys to be successfully authenticated for accessing the resource. The high security setting may require more keys than the medium security setting to be successfully authenticated for accessing a resource.

Of course, slider 300 of FIG. 3A is only exemplary. Many other means of setting security settings may be employed in other embodiments consistent with the subject matter of this disclosure. Further, more or fewer security settings may be set by a slider, such as slider 300, or other slider.

In other embodiments, other means may be employed for setting a security setting, for indicating keys from one or more groups of keys, which may be required to access a resource in certain contexts, and for assigning point values to various keys. In one embodiment, for example, a user may be presented with a large menu of options on a display of a portable processing device. The user may cause checkboxes to be checked next to each option selected. The user may select the checkboxes via a pointing device, such as a computer mouse or other pointing device, or via other devices, such as, for example, an electronic stylus, a user's finger on a touch screen, a keyboard, a keypad, or via other input means.

FIG. 3B illustrates an exemplary menu which may be displayed on a display screen of a portable processing device. The display screen illustrates a security level which the user may select. The user may select a low security level 310, a medium security level 312, or a high security level 314 via, for example, a computer mouse or other pointing device, or via other devices, such as, for example, an electronic stylus, a user's finger on a touch screen, a keyboard, a keypad, or via other input means. In the example of FIG. 3B, a high security level was selected. In this exemplary embodiment, the security level may indicate a type of feedback when a textual password is entered by a user. Further, the user may select a particular key such as, for example, a textual password 320 or a voice recognition key 324, as shown in the exemplary display of FIG. 3B, or other key, and may assign a point value for the key. For example, as shown in FIG. 3B, the user may select a point value of 10 to a sign to a textual password key and a point value of 20 to assign to a voice recognition key. In one embodiment, the point values may be selected by the user from a group of predefined point values for a particular type of key, as shown in FIG. 3B. In other embodiments, the user may enter a numerical value for the point value.

FIG. 3B is only an exemplary display. In other embodiments, numerous other means of assigning a security level and assigning points to a key may be implemented.

### Visual Feedback

When a user enters password text as a key, it is useful to provide the user with feedback, such as, for example, visual feedback, such that if the password text is not accepted, the user may have some indication as to why the password text was not accepted. There are many different ways in which visual feedback may be provided via a display of the portable processing device or system.

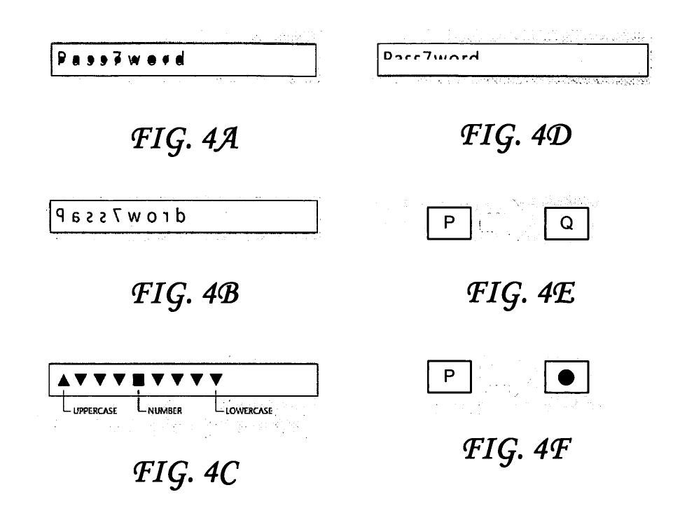

For example, FIG. 4A illustrates a method in which each text character is displayed as being overlaid by a dot as each character is entered.

FIG. 4B illustrates a method in which each text character is displayed in a different orientation as each character is entered. In this example, each character may be flipped horizontally, although other orientations for each character may be employed in other embodiments.

FIG. 4C illustrates a method in which each text character is displayed as a symbol as each character is entered. For example, a triangle with a vertex pointing upward may represent an uppercase character. A triangle rotated 180° from the triangle representing an uppercase character may represent a lowercase character. A square may represent a numeric character.

FIG. 4D illustrates a method in which only a portion of each entered character is displayed as it is entered. In this example, only a top portion of each character is displayed. In other embodiments, other portions of each character may be displayed, such as a bottom portion, or other portion of each character. In some embodiments, a different portion of each character may be displayed as each character is entered.

FIG. 4E illustrates a method in which, as each character is entered, each character may be mapped to a substitute character, which is displayed. The substitution may be performed according to a code defined by the user. FIG. 4E illustrates a letter “Q” being displayed when a letter “P” is entered.

FIG. 4F illustrates a method in which, as each character is entered, each character may be displayed briefly, may then fade, and may be transformed to another character, such as, for example, a dot, or other character.

FIGS. 4A-4F illustrate examples for providing visual feedback when a password is entered as text. Of course, numerous other needs for providing visual feedback may be used in other embodiments consistent with the subject matter of this disclosure. For example, in one embodiment, every N^{th} character may be displayed as it is entered, where N may be configurable.

In some embodiments, a security level may be associated with one or more methods of providing visual feedback during text entry of a password. The security level may be previously assigned to the one or more methods of providing visual feedback or may be configurable. For example, the method of FIG. 4A may be assigned a low security level, the method of FIG. 4C may be assigned a high security level, and the method of FIG. 4E may be assigned a medium security level. In such embodiments, the method for providing visual feedback of text entry of passwords may be selected according to a security level, as indicated by an authentication policy.

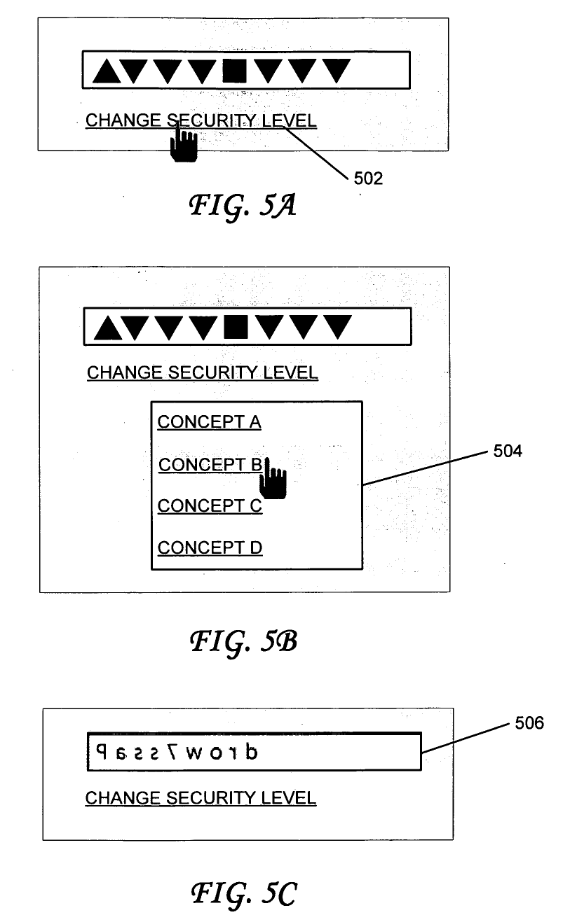

In some embodiments, the security level of the visual feedback may be configured on a per user basis or on a system basis. For example, a user, such as, for example, an individual user or a system administrator, may request to change a security level of the visual feedback, resulting in a display, such as, the exemplary display of FIG. 5A being displayed. In this example, the visual feedback method illustrated by FIG. 4C was previously used. The exemplary display of FIG. 5A displays an indication of the current visual feedback method, in this case triangles and squares, and selectable text 502 or an icon (not shown), which may be selected when the user desires to change the security level of the visual feedback. Upon selecting selectable text 502 or the icon, a menu, such as, for example, menu 504 of FIG. 5B may be displayed. Items from menu 504 may correspond to a respective visual feedback methods. The user may select one of the items, for example, concept B, which may correspond to the method illustrated by FIG. 4B. The selected item may be selected by using a pointing device, such as, for example, a computer mouse, or another input method. Upon selecting the desired visual feedback method, an indicator 506 (FIG. 5C) of the current visual feedback method may be displayed. In this example, the indicator illustrates that, as each character is entered, the character will be displayed in a different orientation, such as, for example, flipped horizontally about a vertical axis.

### Visual Feedback of Non-Textual Keys

As keys are processed during authentication, a user may receive visual feedback indicating acceptance of certain keys such as, for example, non-textual keys. For example, in one embodiment, a user may be provided with visual feedback such as a display of configurable icons appearing when keys are processed during authentication.

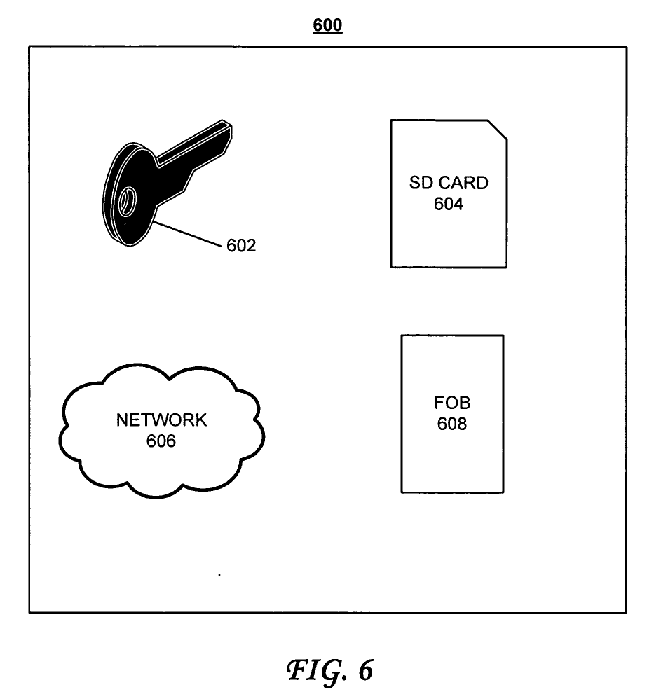

FIG. 6 illustrates an exemplary display 600 in an embodiment consistent with the subject matter of this disclosure indicating that authentication processing has taken place with respect to certain non-textual keys. Exemplary display 600 shows icons 602, 604, 606 and 608, which may be configurable icons. In the example shown in display 600, icon 602 may indicate that a particular key, such as a voice recognition key, a key satisfied by being in a particular location, or another type of key has been processed during authentication. Icon 604 may indicate that a key satisfied by detecting a presence of a SD card has been processed during authentication. Icon 606 may indicate that a key satisfied by detecting a presence of a network has been processed during authentication. Icon 608 may indicate that a key satisfied by a presence of a USB fob has been processed during authentication.

Display 600 is an exemplary display. Other displays indicating progress during authentication with respect to non-textual keys may be displayed in other embodiments consistent with the subject matter of this disclosure. For example, a family portrait may be displayed, with family members being filled in as non-textual keys are processed during authentication. In another embodiment, as non-textual keys are processed during authentication, colored puzzle pieces, which may represent certain non-textual keys, may be shown flying into a display and locking together.

The above-mention displays are only exemplary. Numerous other types of displays may be provided in other embodiments and therefore, are not to be excluded from the scope of the subject matter of this disclosure.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

We claim as our invention:

1. A method for authenticating a user, the method comprising:
determining, based on an authentication policy and a context, whether a predetermined combination of a number of keys and types of keys from at least one group of keys are present at a time when the user wishes to access a resource; and
successfully authenticating the user when the predetermined combination of the number of keys and types of keys from the at least one group of keys are present at the time when the user wishes to access the resource.

2. The method of claim 1, wherein:
each of the keys is assigned a number of points, and
the predetermined combination of the number of keys and the types of keys from the at least one group of key is determined to be present when a total number of points of the predetermined combination of the number of keys and the types of keys exceeds a predetermined value.

3. The method of claim 1, further comprising:
determining at least one pattern regarding when the user attempts to access the resource and which of the keys are used by the user when attempting to access the resource; and
blocking the user from accessing the resource when a context of the attempt to access the resource varies from the determined at least one pattern.

4. The method of claim 1, further comprising:
determining at least one pattern regarding when the user attempts to access the resource and which of the keys are used by the user when attempting to access the resource; and
reporting the attempt to access the resource as suspicious activity when a context of the attempt to access the resource varies from the determined at least one pattern.

5. The method of claim 1, further comprising:
determining at least one pattern regarding when the user attempts to access the resource and which of the keys are used by the user when attempting to access the resource; and
adapting the authentication policy based on the determined at least one pattern.

6. The method of claim 1, wherein:
at least one of the keys is a non-textual key, and
the method further comprising:
providing visual feedback as the non-textual key is processed during authentication.

7. The method of claim 1, wherein:
at least one of the keys is a password to be entered as text, and
the method further comprises:
providing visual feedback as the password is entered, a type of visual feedback being provided is based on the authentication policy.

8. The method of claim 1, wherein:
at least one of the keys is a password to be entered as text,
at least some a plurality of types of feedback are associated with a security level, and the method further comprises:
providing visual feedback as the password is entered, a type of visual feedback being provided is based on the authentication policy;
adapting a security level of the authentication policy;
changing the type of visual feedback provided when the password is entered in accordance with the adapted security level of the authentication policy.

9. A tangible machine-readable medium having recorded thereon instructions for at least one processor, the machine-readable medium comprising:
instructions for receiving a password as text input;
instructions for providing one of a plurality of types of visual feedback as the password is received, at least some of the plurality of types of visual feedback are associated with a security level; and
instructions for providing a different one of the plurality of types of visual feedback as the password is received based on a selected security level, a selected type of visual feedback, or an authentication policy.

10. The tangible machine-readable medium of claim 9, wherein:
the plurality of types of visual feedback include at least one of displaying partially covered characters, displaying characters in a changed visual orientation, displaying characters using different symbols to represent uppercase, lowercase and numeric characters, displaying only a portion of each character, displaying a substitute character for each entered character based on a predefined substitution code, or displaying each character as it is entered and transforming the character to a symbol.

11. The tangible machine-readable medium of claim 9, wherein:
the instructions for providing a different one of the plurality of types of visual feedback as a password is received is based on a selected security level, and
the selected security level is changeable on a per user basis.

12. The tangible machine-readable medium of claim 9, wherein:
the instructions for providing a different one of the plurality of types of visual feedback as a password is received is based on a selected security level, and
the selected security level is changeable on a per system basis.

13. The tangible machine-readable medium of claim 9, further comprising:
instructions for determining, based on the authentication policy and a context, whether a predetermined combination of a number of keys and types of keys from a plurality of groups keys are present at a time when a user wishes to access a resource;
instructions for providing visual feedback as a non-textual key is processed during authentication, the visual feedback including displaying at least one configurable icon on a display screen; and
instructions for successfully authenticating the user when the predetermined combination of the number of keys and the types of keys from the plurality of groups of keys are present at the time when the user wishes to access the resource, wherein
the received password is one of the keys.

14. The tangible machine-readable medium of claim 9, further comprising:
instructions for determining, based on the authentication policy and a context, whether at least one key of a plurality of keys is present when a user wishes to access a resource, each of the plurality of keys being assigned a respective number of points; and
instructions for permitting the user to access the resource only when the at least one key of the plurality of keys that is present has a total number of points exceeding a value, as determined by the authentication policy, wherein
the received password is one of the keys.

15. The tangible machine-readable medium of claim 9, further comprising:
instructions for determining, based on the authentication policy and a context, whether a predetermined combination of a number of keys and types of keys from a plurality of groups of keys are present at a time when a user wishes to access a resource; and
instructions for successfully authenticating the user when the predetermined combination of the number of keys and the types of keys from the plurality of groups of keys are present at the time when the user wishes to access the resource;
instructions for determining at least one pattern regarding when the user attempts to access the resource and which of the keys are used by the user when attempting to access the resource; and
instructions for adapting the authentication policy based on the determined at least one pattern, wherein
the received password is one of the keys.

16. A processing device comprising:
at least one processor;
a bus; and
a memory including instructions for the at least one processor, the bus connecting the at least one processor and the memory, the instructions further comprising:
instructions for adapting an authentication policy for accessing a resource based on a pattern with respect to keys provided when attempting to access the resource and a context when attempting to access the resource, the instructions for adapting an authentication policy for accessing a resource further includes instructions for adjusting a security level of the authentication policy, and
instructions for providing feedback when one of the keys is provided as textual input, a type of feedback being provided being based on the security level of the authentication policy.

17. The processing device of claim 16, wherein the feedback is visual feedback provided as the one of the keys is entered as the textual input.

18. The processing device of claim 16, wherein the context includes a security level assigned with respect to a current location of the processing device when attempting to access the resource.

19. The processing device of claim 16, wherein the instructions further comprise:
instructions for detecting an unfamiliar usage pattern and increasing a security level for authentication when the unfamiliar usage pattern is detected.

20. The processing device of claim 16, wherein the instructions further comprise:
instructions for filling in portions of a displayed item on a display screen as one or more non-textual keys are processed during authentication, and
instructions for changing a type of feedback provided when the security level of the authentication policy is adjusted, wherein:
the instructions for providing feedback when one of the keys is provided as textual input provide one of a plurality of types of visual feedback, at least some of the plurality of types of visual feedback being associated with a security level.
